(19) United States
(12) Patent Application Publication
(10) Pub. No.: US 2022/0204130 A1
(43) Pub. Date: Jun. 30, 2022

(54) CONTROL DEVICE FOR HUMAN-POWERED VEHICLE

(71) Applicant: Shimano Inc., Osaka (JP)

(72) Inventors: Satoshi SHAHANA, Osaka (JP); Akira INOUE, Osaka (JP); Shingo SAKURAI, Osaka (JP)

(21) Appl. No.: 17/557,694

(22) Filed: Dec. 21, 2021

(30) Foreign Application Priority Data
Dec. 28, 2020 (JP) 2020-219511

(51) Int. Cl. B62M 6/50; B62L 3/00; B62J 1/08

(52) U.S. Cl. CPC B62M 6/50; B62M 6/55; B62J 1/08; B62L 3/00

(57) ABSTRACT

A control device is provided for controlling a human-powered vehicle. The control device includes an electronic controller configured to control a motor that applies a propulsion force to the human-powered vehicle. In a case where a predetermined condition is satisfied, the electronic controller is configured to increase at least one of an assist level of the motor, a maximum value of an output of the motor, and the output of the motor. The predetermined condition includes a first condition in which deceleration of the human-powered vehicle in a traveling direction of the human-powered vehicle is greater than or equal to a first threshold value.

### CROSS-REFERENCE TO RELATED APPLICATIONS

This application claims priority to Japanese Patent Application No. 2020-219511, filed on Dec. 28, 2020. The entire disclosure of Japanese Patent Application No. 2020-219511 is hereby incorporated herein by reference.

### BACKGROUND

### Technical Field

The present disclosure generally relates to a control device for a human-powered vehicle.

### Background Information

Japanese Laid-Open Patent Publication No. 10-59260 (Patent Document 1) discloses an example of a human-powered vehicle control device that controls a motor so that a ratio of an assist force produced by the motor to a human driving force becomes a predetermined ratio.

### SUMMARY

One objective of the present disclosure is to provide a control device for a human-powered vehicle that controls a motor, which applies a propulsion force to the human-powered vehicle, in accordance with a traveling state of the human-powered vehicle in a preferred manner.

A control device in accordance with a first aspect of the present disclosure is for a human-powered vehicle. The control device comprises an electronic controller configured to control a motor that applies a propulsion force to the human-powered vehicle. In a case where a predetermined condition is satisfied, the electronic controller is configured to increase at least one of an assist level of the motor, a maximum value of an output of the motor, and the output of the motor. The predetermined condition includes a first condition in which deceleration of the human-powered vehicle in a traveling direction of the human-powered vehicle is greater than or equal to a first threshold value. With the control device according to the first aspect, in a case where the deacceleration of the human-powered vehicle in the traveling direction of the human-powered vehicle is greater than or equal to the first threshold value, at least one of the assist level by the motor, the maximum value of the output of the motor, and the output of the motor is increased. Thus, the motor is controlled in accordance with the traveling state of the human-powered vehicle in a preferred manner. The control device according to the first aspect can reduce the load on a rider, for example, in a case where the human-powered vehicle is suddenly decelerated.

In accordance with a second aspect of the present disclosure, the control device according to the first aspect is configured so that the predetermined condition further includes a second condition in which an input shaft to which a human driving force is input is rotating. The control device according to the second aspect can reduce the load on the rider in a case where the rider is intentionally driving the human-powered vehicle.

In accordance with a third aspect of the present disclosure, the control device according to first or second aspect is configured so that the predetermined condition further includes a third condition in which a human driving force is input to the human-powered vehicle. The control device according to the third aspect can reduce the load on the rider in a case where the rider is intentionally driving the human-powered vehicle.

In accordance with a fourth aspect of the present disclosure, the control device according to any one of the first to third aspects is configured so that the predetermined condition further includes a fourth condition in which an operating device of a brake device of the human-powered vehicle is not being operated. The control device according to the fourth aspect can reduce the load on the rider in a case where the rider has no intention to decelerate the human-powered vehicle.

In accordance with a fifth aspect of the present disclosure, the control device according to any one of the first to fourth aspects is configured so that the predetermined condition includes a fifth condition in which a vehicle speed of the human-powered vehicle increases immediately before the first condition is satisfied. The control device according to the fifth aspect can reduce the load on the rider in a case where the speed of the human-powered vehicle in the traveling direction is significantly changed.

In accordance with a sixth aspect of the present disclosure, the control device according to any one of the first to fifth aspects is configured so that the human-powered vehicle includes a transmission. The transmission is provided in a transmission path of a human driving force of the human-powered vehicle and configured to change a transmission ratio. Further, the electronic controller is configured to control the motor in accordance with first information related to a present transmission ratio of the transmission and second information related to the transmission ratio corresponding to at least one of a first traveling state of the human-powered vehicle and a first traveling environment of the human-powered vehicle. The control device according to the sixth aspect can control the motor in accordance with the present transmission ratio and the transmission ratio corresponding to at least one of the first traveling state and the first traveling environment.

In accordance with a seventh aspect of the present disclosure, the control device according to the sixth aspect is configured so that the predetermined condition includes a sixth condition in which the first information differs from the second information. The control device according to the seventh aspect can reduce the load on the rider without changing the transmission ratio in a case where the present transmission ratio differs from the transmission ratio that corresponds to at least one of the first traveling state and the first traveling environment.

In accordance with an eighth aspect of the present disclosure, the control device according to any one of the first to fifth aspects is configured so that the electronic controller is configured to control a component of the human-powered vehicle in accordance with information related to a vehicle speed of the human-powered vehicle. The component includes at least one of a transmission provided in a transmission path of human driving force in the human-powered vehicle and configured to change a transmission ratio, at least one suspension device, and an adjustable seatpost. The control device according to the eighth aspect can control at least one of the transmission, the at least one suspension device, and the adjustable seatpost in accordance with the information related to the speed of the human-powered vehicle in a preferred manner.

In accordance with a ninth aspect of the present disclosure, the control device according to the eighth aspect is configured so that the component includes the at least one suspension device, and the at least one suspension device includes a front suspension device. Further, the electronic controller is configured to control the front suspension device to increase stiffness of the front suspension device in a case where the deceleration of the human-powered vehicle in the traveling direction of the human-powered vehicle is greater than or equal to a second threshold value. The control device according to the ninth aspect increases the stiffness of the front suspension device in a case where the deceleration of the human-powered vehicle in the traveling direction of the human-powered vehicle is greater than or equal to the second threshold value. This readily increases the traveling stability of the human-powered vehicle.

In accordance with a tenth aspect of the present disclosure, the control device according to the eighth or ninth aspect is configured so that the component includes the adjustable seatpost. The electronic controller is configured to control the adjustable seatpost to decrease a length of the adjustable seatpost in a case where the deceleration of the human-powered vehicle in the traveling direction of the human-powered vehicle is greater than or equal to a third threshold value. The control device according to the tenth aspect decreases the length of the adjustable seatpost in a case where the deceleration of the human-powered vehicle in the traveling direction of the human-powered vehicle is greater than or equal to the third threshold value. Thus, the rider can easily step on the ground.

In accordance with an eleventh aspect of the present disclosure, the control device according to any one of the eighth to tenth aspects is configured so that the component includes the transmission. The electronic controller controls the transmission to decrease the transmission ratio in a case where the deceleration of the human-powered vehicle in the traveling direction of the human-powered vehicle is greater than or equal to a fourth threshold value. The control device according to the eleventh aspect decreases the transmission ratio in a case where the deceleration of the human-powered vehicle in the traveling direction of the human-powered vehicle is greater than or equal to the fourth threshold value. This reduces the load on the rider.

The human-powered vehicle control device in accordance with the present disclosure can control the motor that applies propulsion force to the human-powered vehicle in accordance with the traveling state of the human-powered vehicle in a preferred manner.

### BRIEF DESCRIPTION OF THE DRAWINGS

Referring now to the attached drawings which form a part of this original disclosure.

FIG. 1 is a side elevational view of a human-powered vehicle including a human-powered vehicle control device in accordance with a first embodiment.

FIG. 2 is a block diagram showing the electrical configuration of the human-powered vehicle including the human-powered vehicle control device in accordance with the first embodiment.

FIG. 3 is a flowchart illustrating a process executed by an electronic controller shown in FIG. 2 to change a control state of a motor.

FIG. 4 is a block diagram showing the electrical configuration of a human-powered vehicle including a human-powered vehicle control device in accordance with a second embodiment.

FIG. 5 is a flowchart illustrating a process executed by an electronic controller shown in FIG. 4 to control a motor and a transmission.

FIG. 6 is a block diagram showing the electric configuration of a human-powered vehicle including a human-powered vehicle control device in accordance with a third embodiment.

FIG. 7 is a flowchart illustrating a process executed by an electronic controller shown in FIG. 6 to control a suspension device.

FIG. 8 is a flowchart illustrating a process executed by the electronic controller shown in FIG. 6 to control an adjustable seatpost.

FIG. 9 is a flowchart illustrating a process executed by the electronic controller shown in FIG. 6 to control a transmission.

FIG. 10 is a flowchart illustrating a process executed by an electronic controller of a modification to control a motor.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

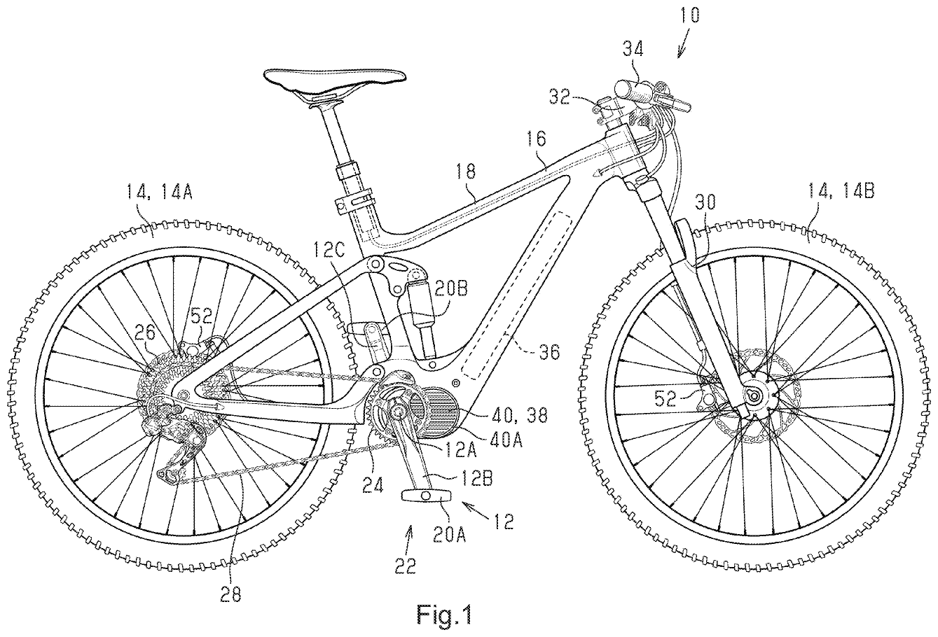

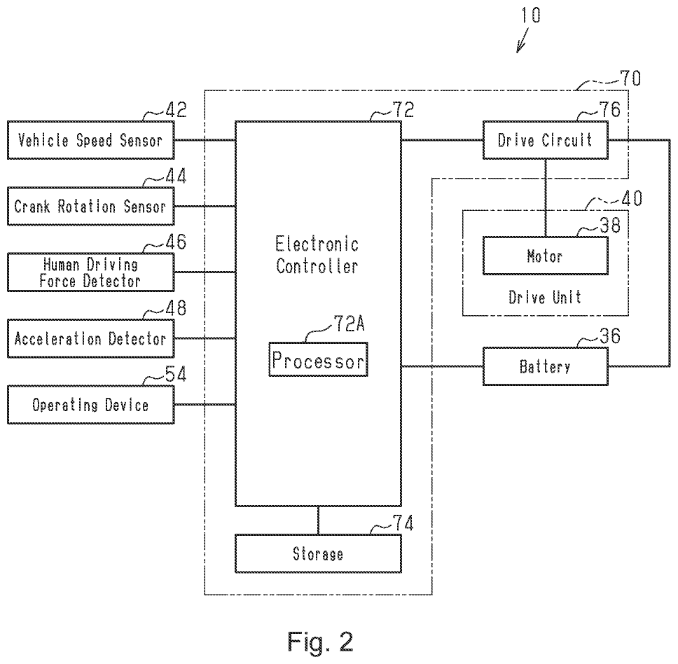

A electronic control device 70 (hereinafter referred to as the control device 70) for a human-powered vehicle in accordance with a first embodiment will now be described with reference to FIGS. 1 to 3. A human-powered vehicle 10 is a vehicle that includes at least one wheel and can be driven by at least a human driving force H. Examples of the human-powered vehicle 10 include various types of bicycles such as a mountain bike, a road bike, a city bike, a cargo bike, a handcycle, and a recumbent bike. There is no limit to the number of wheels of the human-powered vehicle 10. The human-powered vehicle 10 also includes, for example, a unicycle or a vehicle having three or more wheels. The human-powered vehicle 10 is not limited to a vehicle that can be driven only by the human driving force H. The human-powered vehicle 10 includes an electric bicycle (E-bike) that uses a drive force of an electric motor for propulsion in addition to the human driving force H. The E-bike includes an electric assist bicycle that assists in propulsion with an electric motor. In the embodiment described hereafter, the human-powered vehicle 10 will be described as an electric assist bicycle that is also a mountain bike.

The human-powered vehicle 10 includes a crank 12 to which the human driving force H is input. The human-powered vehicle 10 further includes at least one wheel 14 and a vehicle body 16. The at least one wheel 14 includes a rear wheel 14A and a front wheel 14B. The vehicle body 16 includes a frame 18. The crank 12 includes an input shaft 12A, a first crank arm 12B, and a second crank arm 12C. The input shaft 12A is rotatable relative to the frame 18. The first crank arm 12B is provided on a first axial end of the input shaft 12A, and the second crank arm 12C is provided on a second axial end of the input shaft 12A. In the present embodiment, the input shaft 12A is a crank axle. A first pedal 20A is connected to the first crank arm 12B. A second pedal 20B is connected to the second crank arm 12C.

A drive mechanism 22 includes a first rotational body 24 connected to the input shaft 12A. The input shaft 12A can be coupled to the first rotational body 24 in a manner restricting relative rotation of the input shaft 12A and the first rotational body 24. Alternatively, the input shaft 12A can be coupled to the first rotational body 24 by a one-way clutch. The first one-way clutch is configured to rotate the first rotational body 24 forward in a case where the crank 12 is rotated forward and allow relative rotation of the crank 12 and the first rotational body 24 in a case where the crank 12 is rotated rearward. The first rotational body 24 includes a sprocket, a pulley, or a bevel gear. The drive mechanism 22 further includes a second rotational body 26 and a linking member 28. The linking member 28 transmits the rotational force of the first rotational body 24 to the second rotational body 26. The linking member 28 includes, for example, a chain, a belt, or a shaft.

The second rotational body 26 is connected to the rear wheel 14A. The second rotational body 26 includes a sprocket, a pulley, or a bevel gear. Preferably, a second one-way clutch is provided between the second rotational body 26 and the rear wheel 14A. The second one-way clutch is configured to rotate the rear wheel 14A forward in a case where the second rotational body 26 is rotated forward and allow relative rotation of the second rotational body 26 and the rear wheel 14A in a case where the second rotational body 26 is rotated rearward. The human-powered vehicle 10 can include a transmission. The transmission includes at least one of an external transmission device and an internal transmission device. The external transmission device includes, for example, a derailleur, the first rotational body 24, and the second rotational body 26. A derailleur includes at least one of a front derailleur and a rear derailleur. The first rotational body 24 can include a plurality of sprockets. The second rotational body 26 can include a plurality of sprockets. An internal transmission device can be provided, for example, on a hub of the rear wheel 14A or in a power transmission path extending from the input shaft 12A to the first rotational body 24.

The front wheel 14B is attached to the frame 18 by a front fork 30. A handlebar 34 is connected to the front fork 30 by a stem 32. In the present embodiment, the rear wheel 14A is connected to the crank 12 by the drive mechanism 22. Alternatively, at least one of the rear wheel 14A and the front wheel 14B can be connected to the crank 12 by the drive mechanism 22.

The human-powered vehicle 10 further includes a battery 36. The battery 36 includes one or more battery cells. Each battery cell includes a rechargeable battery. The battery 36 is configured to supply the control device 70 with electric power. Preferably, the battery 36 is connected to an electronic controller 72 of the control device 70 via an electric cable or a wireless communication device in a manner allowing for communication. The battery 36 is configured to establish communication with the electronic controller 72 through, for example, power line communication (PLC), Controller Area Network (CAN), or Universal Asynchronous Receiver/Transmitter (UART).

The human-powered vehicle 10 includes a motor 38 configured to apply a propulsion force to the human-powered vehicle 10. The motor 38 includes at least one electric motor. The electric motor is, for example, a brushless motor. The motor 38 is configured to transmit a rotational force to at least one of the front wheel 14B and a power transmission path of the human driving force H extending from the pedals 20A and 20B to the rear wheel 14A. The power transmission path of the human driving force H from the pedals 20A and 20B to the rear wheel 14A includes the rear wheel 14A. In the present embodiment, the motor 38 is provided on the frame 18 of the human-powered vehicle 10 and configured to transmit a rotational force to the first rotational body 24. Thus, the motor 40 constitutes an assist motor.

The motor 38 is provided in a housing 40A. The housing 40A is provided on the frame 18. The housing 40A is, for example, attached to the frame 18 in a detachable manner. The motor 38 and the housing 40A on which the motor 38 is provided define a drive unit 40. The drive unit 40 can include a speed reducer connected to an output shaft of the motor 38. In the present embodiment, the housing 40A rotatably supports the input shaft 12A. In the present embodiment, a third one-way clutch is provided in the power transmission path between the motor 38 and the input shaft 12A to restrict transmission of the rotational force of the crank 12 to the motor 38 in a case where the input shaft 12A is rotated in a direction in which the human-powered vehicle 10 moves forward. In a case where the motor 38 is provided on at least one of the rear wheel 14A and the front wheel 14B, the motor 38 can be provided on a hub and form a hub motor with the hub.

The control device 70 includes the electronic controller 72. The electronic controller 72 includes one or more processors 72A that execute predetermined control programs. The processors of the electronic controller 72 include, for example, a central processing unit (CPU) or a micro-processing unit (MPU). The processors 72A of the electronic controller 72 can be located at separate positions. For example, some of the processors 72A can be provided on the human-powered vehicle 10, and the other processors 72A can be provided in a server connected to the internet. In a case where the processors 72A are located at separate positions, the processors 72A are connected to one another via a wireless communication device in a manner allowing for communication. The electronic controller 72 can include one or more microcomputers. Thus, the term “electronic controller” as used herein refers to hardware that executes a software program, and does not include a human.

Preferably, the control device 70 further includes storage 74. The storage 74 stores control programs and information used for control processes. The storage 74 includes any computer storage device or any non-transitory computer-readable medium with the sole exception of a transitory, propagating signal. For example, the storage 64 includes a non-volatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM).

Preferably, the control device 70 further includes a drive circuit 76 of the motor 38. Preferably, the drive circuit 76 and the electronic controller 72 are provided in a housing 40A of the drive unit 40. The drive circuit 76 and the electronic controller 72 can be provided on, for example, the same circuit substrate. The drive circuit 76 includes an inverter circuit. The drive circuit 76 controls the electric power supplied from the battery 36 to the motor 38. The drive circuit 76 is connected to the electronic controller 72 via a conductive wire, an electric cable or a wireless communication device, and the like. The drive circuit 76 drives the motor 38 in response to control signals from the electronic controller 72.

Preferably, the human-powered vehicle 10 further includes a vehicle speed sensor 42. Preferably, the human-powered vehicle 10 further includes at least one of a crank rotation sensor 44 and a human driving force detector 46. The terms “sensor” and as “detector” used herein refers to a hardware device or instrument designed to detect the presence or absence of a particular event, object, substance, or a change in its environment, and to emit a signal in response. The terms “sensor” and as “detector” as used herein does not include a human.

The vehicle speed sensor 42 is configured to detect information related to a vehicle speed V of the human-powered vehicle 10. In the present embodiment, the vehicle speed sensor 42 is configured to detect information related to a rotational speed CW of the at least one wheel 14 of the human-powered vehicle 10. The vehicle speed sensor 42 is configured to detect, for example, a magnet provided on the at least one wheel 14 of the human-powered vehicle 10. The vehicle speed sensor 42 is, for example, configured to output a predetermined number of detection signals during a period in which one wheel 14 of the at least one wheel 14 completes one rotation. The predetermined number is, for example, one. The vehicle speed sensor 42 outputs signals corresponding to the rotational speed CW of the wheel 14. The electronic controller 72 can calculate the vehicle speed V of the human-powered vehicle 10 based on the signal corresponding to the rotational speed CW of the wheel 14 and information related to the circumferential length of the wheel 14. The storage 74 stores the information related to the circumferential length of the wheel 14.

The vehicle speed sensor 42 includes, for example, a magnetic sensor such as a magnetic reed that forms a reed switch or a Hall element. The vehicle speed sensor 42 can be mounted on a chain stay of the frame 18 of the human-powered vehicle 10 and configured to detect a magnet mounted on the rear wheel 14A, or provided on the front fork 30 and configured to detect a magnet mounted on the front wheel 14B. In the present embodiment, the vehicle speed sensor 42 is configured so that a reed switch detects a magnet whenever the wheel 14 rotates once. The vehicle speed sensor 42 can have any configuration as long as information related to the vehicle speed V of the human-powered vehicle 10 is obtained. For example, the vehicle speed sensor 42 does not have to be configured to detect the magnet provided on the wheel 14 and can be configured to detect a slit provided in a disc brake. Alternatively, the vehicle speed sensor can include a global positioning system (GPS) receiver or an optical sensor and the like. In a case where the vehicle speed sensor 42 includes a GPS receiver, the electronic controller 72 can calculate the vehicle speed V from the time and the distance moved. The vehicle speed sensor 42 is connected to the electronic controller 72 via a wireless communication device or an electric cable.

The crank rotation sensor 44 is configured to detect information related to a rotational speed NC of the input shaft 12A. The crank rotation sensor 44 is provided on, for example, the frame 18 or the drive unit 40 of the human-powered vehicle 10. The crank rotation sensor 44 can be provided on the housing 40A of the drive unit 40. The crank rotation sensor 44 includes a magnetic sensor that outputs signals corresponding to the strength of the magnetic field. A ring-shaped magnet of which the magnetic field changes in a circumferential direction is provided on the input shaft 12A, a member that is rotated in cooperation with the input shaft 12A, or in the power transmission path from the input shaft 12A to the first rotational body 24. The member that is rotated in cooperation with the input shaft 12A can include the output shaft of the motor 38.

The crank rotation sensor 44 outputs signals corresponding to the rotational speed NC of the input shaft 12A. For example, in a case where the first one-way clutch is not provided between the input shaft 12A and the first rotational body 24, the magnet can be provided on the first rotational body 24. The crank rotation sensor 44 can have any configuration as long as information related to the rotational speed NC of the input shaft 12A is obtained. Instead of the magnetic sensor, the crank rotation sensor 44 can include an optical sensor, an acceleration sensor, a gyro sensor, a torque sensor, or the like. The crank rotation sensor 44 is connected to the electronic controller 72 via a wireless communication device or an electric cable.

The human driving force detector 46 is configured to detect information related to the human driving force H. The human driving force detector 46 is provided on, for example, the frame 18, the drive unit 40, the crank 12, or the pedals 20A or 20B of the human-powered vehicle 10. The human driving force detector 46 can be provided on the housing 40A of the drive unit 40. The human driving force detector 46 includes, for example, a torque sensor. The torque sensor is configured to output signals corresponding to a torque applied to the crank 12 by the human driving force H. For example, in a case where the first one-way clutch is provided in the power transmission path, it is preferred that the torque sensor be provided at an upstream side of the first one-way clutch in the power transmission path. The torque sensor includes a strain sensor, a magnetostrictive sensor, a pressure sensor, and the like. A strain sensor includes a strain gauge.

The torque sensor is provided on a member included in the power transmission path or near the member included in the power transmission path. The member included in the power transmission path is, for example, the input shaft 12A, a member that transmits the human driving force H between the input shaft 12A and the first rotational body 24, the crank arms 12B and 12C, or the pedals 20A and 20B. The human driving force detector 46 is connected to the electronic controller 72 via a wireless communication device or an electric cable. The human driving force detector 46 can have any configuration as long as information related to the human driving force H is obtained. For example, the human driving force detector 46 can include a sensor that detects the pressure applied to the pedals 20A and 20B, a sensor that detects the tension on the chain, and the like.

The human-powered vehicle 10 further includes a brake device 52 and an operating device 54 of the brake device 52. Preferably, the human-powered vehicle 10 further includes at least one of the crank rotation sensor 44 and the human driving force detector 46. The brake device 52 is provided on the frame 18 and the front fork 30 and configured to apply brake force to the wheel 14. The brake device 52 can be a disc brake, a rim brake, or a roller brake. The operating device 54 is provided, for example, on the handlebar 34. The operating device 54 includes a brake lever and a brake sensor that outputs information corresponding to an operation state of the brake lever. The brake sensor includes, for example, a magnetic sensor, an optical sensor, or a potentiometer. The brake sensor is connected to the electronic controller 72 via a wireless communication device or an electric cable. The brake sensor can be provided on a Bowden cable or the brake device 52 instead of the operating device 54. The brake sensor can be configured by any sensor as long as the operation state of the brake device 52 is detected. In the present embodiment, in a case where the brake lever is operated, the brake sensor outputs a predetermined signal to the electronic controller 72.

The electronic controller 72 is configured to control the motor 38 that applies a propulsion force to the human-powered vehicle 10. Preferably, the electronic controller 72 is configured to control the motor 38 in accordance with the human driving force H input to the human-powered vehicle 10. The human driving force H can be expressed in torque or power.

The electronic controller 72 is configured to control the motor 38 so that, for example, an assist level A of the motor 38 is a predetermined assist level A. The assist level A includes a ratio of the assist force produced by the motor 38 to the human driving force H or a ratio of the assist force produced by the motor 38 to the rotational speed of the crank 12. The ratio of the assist force produced by the motor 38 to the human driving force H can also be described as the assist ratio. The electronic controller 72 is configured to control the motor 38 so that, for example, the ratio of the assist force produced by the motor 38 to the human driving force H is a predetermined ratio. The human driving force H corresponds to the propulsion force of the human-powered vehicle 10 produced by a user rotating the crank 12. The assist force corresponds to the propulsion force of the human-powered vehicle 10 produced by the motor 38. The predetermined ratio does not have to be a constant value. For example, the predetermined ratio can be changed in accordance with the human driving force H, the rotational speed NC of the input shaft 12A, or the vehicle speed V. Further, the predetermined ratio can be changed in accordance with any two or every one of the human driving force H, the rotational speed NC of the input shaft 12A, and the vehicle speed V.

In a case where the human driving force H and the assist force are expressed in torque, the human driving force H will be referred to as human torque HT, and the assist force will be referred to as assist torque MT. In a case where the human driving force H and the assist force are expressed in power, the human driving force H will be referred to as power based on human force HW, and the assist force will be referred to as power based on assist force MW. The ratio can be a torque ratio of the assist torque MT to the human torque HT of the human-powered vehicle 10 or a ratio of the power based on assist force MW produced by the motor 38 to the power based on the human force HW.

In the drive unit 40 of the present embodiment, the crank 12 is connected to the first rotational body 24 without the transmission, and an output M of the motor 38 is input to the first rotational body 24. In a case where the crank 12 is connected to the first rotational body 24 without the transmission and the output M of the motor 38 is input to the first rotational body 24, the human driving force H corresponds to the driving force input to the first rotational body 24 in a case where a user rotates the crank 12. In a case where the crank 12 is connected to the first rotational body 24 without the transmission and the output M of the motor 38 is input to the first rotational body 24, the assist force corresponds to the driving force input to the first rotational body 24 in a case where the motor 38 is rotated. In a case where the output M of the motor 38 is input to the first rotational body 24 by the speed reducer, the assist force corresponds to an output of the speed reducer.

In a case where the motor 38 is provided on the rear wheel 14A, the human driving force H corresponds to an output of the rear wheel 14A that is driven only by a user. In a case where the motor 38 is provided on the rear wheel 14A, the assist force corresponds to an output of the rear wheel 14A that is driven only by the motor 38. In a case where the motor 38 is provided on the front wheel 14B, the human driving force H corresponds to an output of the rear wheel 14A that is driven only by the user. In a case where the motor 38 is provided on the front wheel 14B, the assist force corresponds to an output of the front wheel 14B that is driven only by the motor 38.

The electronic controller 72 is configured to control the motor 38 so that the assist force is less than or equal to a maximum value Mmax. In a case where the output M of the motor 38 is input to the first rotational body 24 and the assist force is expressed in torque, the electronic controller 72 is configured to control the motor 38 so that the assist torque MT is less than or equal to a maximum value MTX. Preferably, the maximum value MTX is a value in the range of 20 Nm or greater and 200 Nm or less. In a case where the output M of the motor 38 is input to the first rotational body 24 and the assist force is expressed in power, the electronic controller 72 is configured to control the motor 38 so that the power based on assist force MW is less than or equal to a maximum value MWX.

Preferably, the human-powered vehicle 10 includes an acceleration detector 48. The acceleration detector 48 is configured to output signals corresponding to acceleration in a direction in which the human-powered vehicle 10 moves forward. The acceleration detector 48 can include an acceleration sensor. Further, the acceleration detector 48 can include the vehicle speed sensor 42. The acceleration detector 48 is connected to the electronic controller 72 via a wireless communication device or an electric cable. In a case where the acceleration detector 48 includes the vehicle speed sensor 42, the electronic controller 72 obtains information related to the acceleration in the direction in which the human-powered vehicle 10 moves forward by differentiating the vehicle speed V.

The electronic controller 72 can be configured to calculate deceleration D of the human-powered vehicle 10 in a traveling direction of the human-powered vehicle 10 in accordance with an output of the acceleration detector 48. The deceleration D is expressed as a value that increases as the human-powered vehicle 10 decelerates. As the deceleration D increases, the vehicle speed V of the human-powered vehicle 10 is decreased more significantly.

The electronic controller 72 is configured to control the motor 38 that applies propulsion force to the human-powered vehicle 10. In a case where a predetermined condition is satisfied, the electronic controller 72 increases at least one of the assist level A of the motor 38, the maximum value Mmax of the output M of the motor 38, and the output M of the motor 38.

Preferably, the predetermined condition includes a first condition in which the deceleration D of the human-powered vehicle 10 in the traveling direction of the human-powered vehicle 10 is greater than or equal to a first threshold value DX. The first threshold value DX is, for example, 3 km/h/second or greater and 8.5 km/h/second or less. Instead of the first condition, the predetermined condition can include a seventh condition in which the deceleration D of the human-powered vehicle 10 in the traveling direction of the human-powered vehicle 10 is greater than or equal to the first threshold value DX and less than or equal to a fifth threshold value DV. The fifth threshold value DV is greater than the first threshold value DX. The fifth threshold value DV is, for example, 3 km/h/second or greater and 8.5 km/h/second or less. For example, the first condition or the seventh condition is satisfied in a case where the road on which the human-powered vehicle 10 is traveling suddenly changes from a downhill road to an uphill road.

Preferably, the seventh condition is satisfied in a case where the deceleration D of the human-powered vehicle 10 in the traveling direction of the human-powered vehicle 10 is 3 km/h/second or greater and 8.5 km/h/second or less. Further preferably, the seventh condition is satisfied in a case where the deceleration D of the human-powered vehicle 10 in the traveling direction of the human-powered vehicle 10 is 4 km/h/second or greater and 7 km/h/second or less. In a case where the deceleration D of the human-powered vehicle 10 in the traveling direction of the human-powered vehicle 10 exceeds the fifth threshold value DV, it is highly probable that the rider is intentionally braking the human-powered vehicle 10 with the brake device 52. The electronic controller 72 can restrict increases in at least one of the assist level A of the motor 38, the maximum value Mmax of the output M of the motor 38, and the output M of the motor 38 in a case where the rider is intentionally braking the human-powered vehicle 10 with the brake device 52 by including the seventh condition in the predetermined condition.

Preferably, the predetermined condition further includes a second condition in which the input shaft 12A to which the human driving force H is input is rotating. For example, in a case where the rotational speed NC of the input shaft 12A is greater than a predetermined rotational speed CX, the electronic controller 72 determines that the input shaft 12A is rotating. Preferably, the predetermined rotational speed CX is a value in the range of 0 rpm or greater and 5 rpm or less. The predetermined rotational speed CX is, for example, 0 rpm.

Preferably, the predetermined condition further includes a third condition in which the human driving force H is input to the human-powered vehicle 10. For example, in a case where the human driving force H is greater than a predetermined driving force HX, the electronic controller 72 determines that the human driving force H is input to the human-powered vehicle 10. The predetermined driving force HX is, for example, a value in the range of 0 Nm or greater and 5 Nm or less. The predetermined driving force HX is, for example, 0 Nm.

Preferably, the predetermined condition further includes a fourth condition in which the operating device 54 of the brake device 52 of the human-powered vehicle 10 is not being operated. Preferably, the predetermined condition includes a fifth condition in which the vehicle speed V of the human-powered vehicle 10 increases immediately before the first condition is satisfied. The electronic controller 72 determines that the fifth condition is satisfied, for example, in a case where the deceleration D becomes greater than or equal to the first threshold value DX within a predetermined period from when the vehicle speed V is increased. The predetermined period is, for example, in a range of 0.1 second or greater and five seconds or less.

The predetermined condition can include only the first condition. The predetermined condition can include only the seventh condition. In addition to the first condition or the seventh condition, the predetermined condition can include at least one of the second, third, fourth, and fifth conditions. Preferably, the electronic controller 72 determines that the predetermined condition is satisfied in a case where every one of the conditions included in the predetermined condition is satisfied.

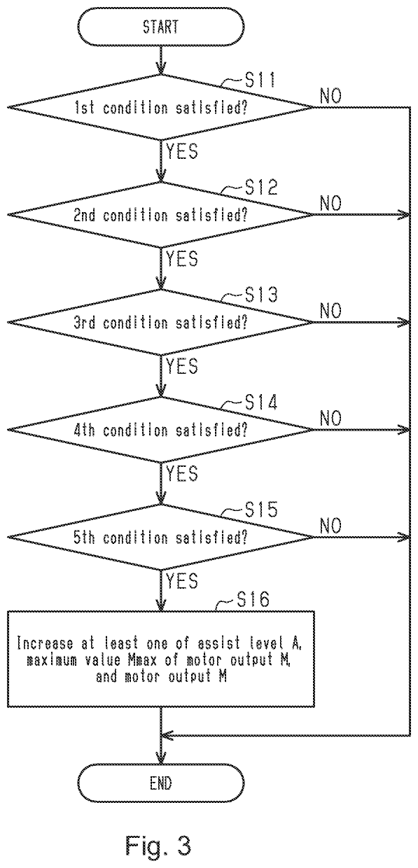

A process for shifting a control state in which the electronic controller 72 controls the motor 38 will now be described with reference to FIG. 3. For example, in a case where electric power is supplied to the electronic controller 72, the electronic controller 72 starts the process of the flowchart shown in FIG. 3 from step S11. In a case where the process of the flowchart shown in FIG. 3 ends, the electronic controller 72 repeats the process from step S11 in predetermined cycles, for example, until the supply of electric power stops.

In step S11, the electronic controller 72 determines whether the first condition is satisfied. In a case where the first condition is not satisfied, the electronic controller 72 ends processing. In a case where the first condition is satisfied, the electronic controller 72 proceeds to step S12. The electronic controller 72 can obtain the deceleration D a number of times and determine that the first condition is satisfied in a case where the deceleration D is consecutively greater than or equal to the first threshold value DX a number of times in step S11. The electronic controller 72 can obtain the deceleration D, for example, whenever a predetermined time elapses or whenever the wheel 14 completes one rotation.

In step S11, instead of the first condition, the electronic controller 72 can determine whether the seventh condition is satisfied. In a case where the seventh condition is not satisfied, the electronic controller 72 ends processing. In a case where the seventh condition is satisfied, the electronic controller 72 proceeds to step S12. The electronic controller 72 can obtain the deceleration D a number of times and determine that the seventh condition is satisfied in a case where the deceleration D is consecutively greater than or equal to the first threshold value DX and less than or equal to the fifth threshold value a number of times in step S11.

In step S12, the electronic controller 72 determines whether the second condition is satisfied. In a case where the second condition is not satisfied, the electronic controller 72 ends processing. In a case where the second condition is satisfied, the electronic controller 72 proceeds to step S13. The electronic controller 72 can obtain the rotational speed NC of the input shaft 12A a number of times and determine that the second condition is satisfied in a case where the rotational speed NC of the input shaft 12A is consecutively greater than the predetermined rotational speed CX a number of times in step S12. The electronic controller 72 can obtain the predetermined rotational speed CX, for example, whenever a predetermined time elapses.

In step S13, the electronic controller 72 determines whether the third condition is satisfied. In a case where the third condition is not satisfied, the electronic controller 72 ends processing. In a case where the third condition is satisfied, the electronic controller 72 proceeds to step S14. The electronic controller 72 can obtain the human driving force H a number of times and determine that the third condition is satisfied in a case where the human driving force H is consecutively greater than the predetermined driving force HX a number of times in step S13. The electronic controller 72 can obtain the human driving force H, for example, whenever a predetermined time elapses.

In step S14, the electronic controller 72 determines whether the fourth condition is satisfied. In a case where the fourth condition is not satisfied, the electronic controller 72 ends processing. In a case where the fourth condition is satisfied, the electronic controller 72 proceeds to step S15. The electronic controller 72 can obtain information detected by the brake sensor a number of times and determine that the third condition is satisfied in a case where the information detected by the brake sensor consecutively indicates that the brake device 52 is not being operated a number of times in step S14. The electronic controller 72 can obtain the information detected by the brake sensor, for example, whenever a predetermined time elapses.

In step S15, the electronic controller 72 determines whether the fifth condition is satisfied. In a case where the fifth condition is not satisfied, the electronic controller 72 ends processing. In a case where the fifth condition is satisfied, the electronic controller 72 proceeds to step S16. In step S16, the electronic controller 72 increases at least one of the assist level A, the maximum value Mmax of the output M of the motor 38, and the output M of the motor 38 and then ends processing.

Steps S11, S12, S13, S14, and S15 can be performed in any order. Step S16 will not be performed in a case where a negative determination is given in at least one of steps S11, S12, S13, S14, and S15. In the present embodiment, step S16 will be performed in a case where an affirmative determination is given in every one of steps S11, S12, S13, S14, and S15. At least one of steps S12, S13, S14, and S15 can be omitted.

In a case where the vehicle speed V of the human-powered vehicle 10 is greater than or equal to a predetermined speed VX, the electronic controller 72 can prohibit switching of the control state in which the motor 38 is controlled in accordance with the deceleration D. The predetermined speed VX is, for example, a value in the range of thirty km per hour to forty-five km per hour.

In the present embodiment, the deceleration D can be replaced by deceleration energy. Deceleration energy is expressed by ½×M×V². Here, “M” can be the weight of the human-powered vehicle 10 or the sum of the weight of the human-powered vehicle 10 and the weight of the rider. The storage 74 stores information related to the weight of the human-powered vehicle 10 or information related to the sum of the weight of the human-powered vehicle 10 and the weight of the rider. The first threshold value DX and the fifth threshold value DV are changed to values that correspond to deceleration energy. For example, the deceleration energy differs between a case where the human-powered vehicle 10 is decelerated from ten km per hour and a case where the human-powered vehicle 10 is decelerated from thirty-five km per hour while the deceleration D is the same between the two cases. Thus, if the electronic controller 72 shifts the control state in which the motor 38 is controlled using the deceleration energy, the motor 38 can be controlled in a further preferred manner.

### Second Embodiment

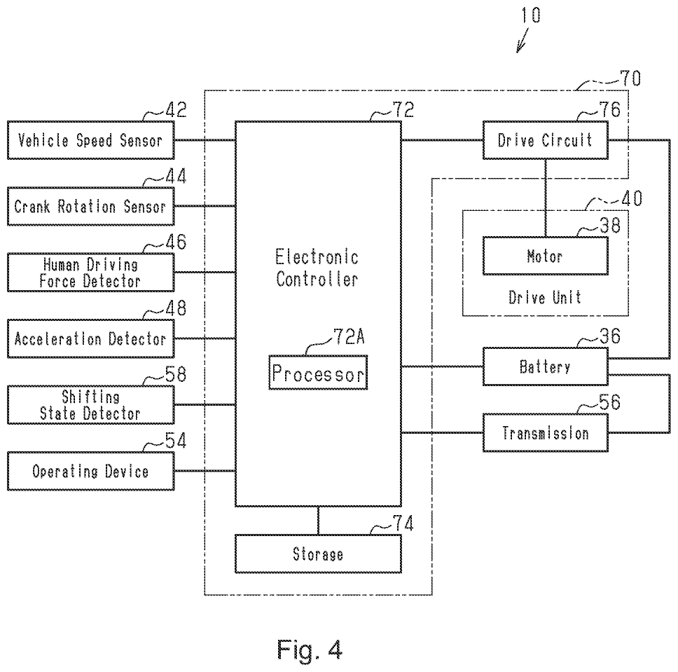

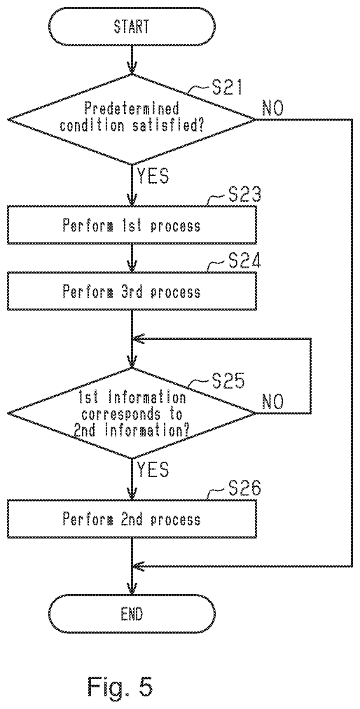

The control device 70 in accordance with a second embodiment will now be described with reference to FIGS. 4 and 5. The control device 70 of the second embodiment is configured in the same manner as the control device 70 of the first embodiment except in that the electronic controller 72 is configured to control a transmission 56 and that the process of the flowchart shown in FIG. 5 is performed instead of the process of the flowchart shown in FIG. 3. Thus, same reference numerals are given to those components of the control device 70 in the second embodiment that are the same as the corresponding components in the first embodiment. Such components will not be described in detail.

In the present embodiment, the human-powered vehicle 10 includes the transmission 56. The transmission 56 is provided in the transmission path of the human driving force H of the human-powered vehicle 10 and configured to change a transmission ratio R.

The transmission 56 is provided on the transmission path of the human driving force H and configured to change the transmission ratio R. The transmission 56 includes multiple transmission stages. The transmission stages differ from one another in the corresponding transmission ratio R. The number of transmission stages is, for example, in a range of three to thirty. The transmission ratio R is a ratio of the rotational speed of the driving wheel to the rotational speed NC of the input shaft 12A. In the present embodiment, the driving wheel is the rear wheel 14A. The transmission 56 includes, for example, at least one of a front derailleur, a rear derailleur, and an internal transmission device. In a case where the transmission 56 includes an internal transmission device, the internal transmission device is provided on, for example, a hub of the rear wheel 14A. The internal transmission device can include a continuously variable transmission (CVT).

The transmission 56 includes an electric transmission configured to be actuated by an actuator. In a case where the transmission 56 includes a front derailleur, the transmission 56 includes the first rotational body 24. Further, the first rotational body 24 includes a plurality of sprockets. In a case where the transmission 56 includes a rear derailleur, the transmission 56 includes the second rotational body 26. Further, the second rotational body 26 includes a plurality of sprockets. The transmission 56 includes an electric transmission configured to be actuated by an actuator. An actuator includes an electric actuator. An actuator includes, for example, an electric motor. The relationship of the transmission ratio R, a rotational speed NW of the driving wheel, and the rotational speed NC of the input shaft 12A satisfies the following equation (1).

transmission ratio R=rotational speed NW/rotational speed NC Equation (1):

The rotational speed NW of the driving wheel and the rotational speed NC of the input shaft 12A can each be the number of rotations per unit time. The rotational speed NW of the driving wheel can be replaced by the number of teeth of the front sprocket, and the rotational speed NC of the input shaft 12A can be replaced by the number of teeth of the rear sprocket.

The electronic controller 72 controls the motor 38 in accordance with first information related to the present transmission ratio R of the transmission 56 and second information related to the transmission ratio R corresponding to at least one of a first traveling state of the human-powered vehicle 10 and a first traveling environment of the human-powered vehicle 10. The first traveling state includes, for example, at least one of the vehicle speed V of the human-powered vehicle 10, an acceleration of the human-powered vehicle 10 in the traveling direction of the human-powered vehicle 10, and the rotational speed of the crank 12. The first traveling environment includes at least one of an inclination of the road on which the human-powered vehicle 10 is traveling, the weather, humidity, and brightness. The storage 74 stores third information in which at least one of the first traveling state and the first traveling environment is associated with the transmission ratios R. The third information includes, for example, a table. The electronic controller 72 determines the second information in accordance with the third information stored in the storage 74.

Table 1 shows an example of the third information. Table 1 relates a transmission that can change the transmission ratio between seven stages. In table 1, V1<V2<V3<V4<V5<V6<V7 is satisfied. In table 1, R1<R2<R3<R4<R5<R6<R7 is satisfied.

TABLE 1

| | Transmission |
|---|---|
| Vehicle Speed V of Human-Powered Vehicle 10 | Ratio R |
| Greater than or equal to 0 and less than V1 | R1 |
| Greater than or equal to V1 and less than V2 | R2 |
| Greater than or equal to V2 and less than V3 | R3 |
| Greater than or equal to V3 and less than V4 | R4 |
| Greater than or equal to V4 and less than V5 | R5 |
| Greater than or equal to V5 and less than V6 | R6 |
| Greater than or equal to V6 and less than V7 | R7 |

Preferably, the human-powered vehicle 10 includes a shifting state detector 58. The shifting state detector 58 is configured to detect the first information. In a case where the transmission 56 is a derailleur, the shifting state detector 58 outputs signals corresponding to the position of the derailleur. The shifting state detector 58 can output signals corresponding to an operation position of a transmission operation device. In a case where the transmission operation device and the transmission 56 is connected by a Bowden cable, the shifting state detector 58 can output signals corresponding to at least one of the position of the Bowden cable and actuation of the Bowden cable. The shifting state detector 58 includes, for example, a magnetic sensor, an optical sensor, or a potentiometer. The shifting state detector 58 is connected to the electronic controller 72 via a wireless communication device or an electric cable.

In the present embodiment, the predetermined condition includes a sixth condition in which the first information differs from the second information. The predetermined condition can include only the first and sixth conditions. Alternatively, in addition to the first and sixth conditions, the predetermined condition can include at least one of the second, third, fourth, and fifth conditions. The first condition can be replaced by the seventh condition. Preferably, the electronic controller 72 determines that the predetermined condition is satisfied in a case where every one of the conditions included in the predetermined condition is satisfied.

Preferably, in a case where the predetermined condition is satisfied, the electronic controller 72 controls the transmission 56 so that the first information corresponds to the second information. Preferably, in a case where the predetermined condition is satisfied, the electronic controller 72 performs a third process for controlling the transmission 56 so that first information corresponds to the second information.

In a case where the electronic controller 72 performs a first process, it is preferred that the third process be performed after the first process and that a second process be performed if the first information corresponds to the second information. In a case where the electronic controller 72 performs the second process, it is preferred that the third process be performed after the first process and that the second process be performed if the first information corresponds to the second information.

Preferably, in the first process, the electronic controller 72 increases at least one of the assist level A of the motor 38, the maximum value Mmax of the output M of the motor 38, and the output M of the motor 38. In the second process, the electronic controller 72 decreases at least one of the assist level A of the motor 38, the maximum value Mmax of the output M of the motor 38, and the output M of the motor 38.

A process for shifting the control state in which the electronic controller 72 controls the motor 38 will now be described with reference to FIG. 5. For example, in a case where electric power is supplied to the electronic controller 72, the electronic controller 72 starts the process of the flowchart shown in FIG. 5 from step S21. In a case where the process of the flowchart shown in FIG. 5 ends, the electronic controller 72 repeats the process from step S21 in predetermined cycles, for example, until the supply of electric power stops.

In step S21, the electronic controller 72 determines whether the predetermined condition is satisfied. In a case where the predetermined condition is not satisfied, the electronic controller 72 ends processing. In a case where the predetermined condition is satisfied, the electronic controller 72 proceeds to step S23.

In step S23, the electronic controller 72 performs the first process and proceeds to step S24. In the present embodiment, if the electronic controller 72 performs the first process in a case where, for example, the transmission ratio R corresponding to the first information is less than the transmission ratio R corresponding to the second information, the assist force produced by the motor 38 will be sufficient even in a case where the human-powered vehicle 10 is suddenly decelerated. The electronic controller 72 can perform the first process, for example, in a case where the transmission ratio R corresponding to the first information is greater than the transmission ratio R corresponding to the second information. In this case, the load on the rider can be reduced even in a case where the actual transmission ratio R is greater than the ideal transmission ratio R.

In step S24, the electronic controller 72 performs the third process and proceeds to step S25. In step S25, the electronic controller 72 determines whether the first information corresponds to the second information. In a case where the first information does not correspond to the second information, the electronic controller 72 performs step S25 again. In a case where the first information corresponds to the second information, the electronic controller 72 proceeds to step S26.

In step S26, the electronic controller 72 performs the second process and then ends processing. Preferably, in step S26, the electronic controller 72 decreases at least one of the assist level A of the motor 38, the maximum value Mmax of the output M of the motor 38, and the output M of the motor 38 to the state prior to the second process in step S23. Preferably, in step S26, the electronic controller 72 decreases at least one of the assist level A of the motor 38, the maximum value Mmax of the output M of the motor 38, and the output M of the motor 38 to the state immediately prior to the second process in step S23.

### Third Embodiment

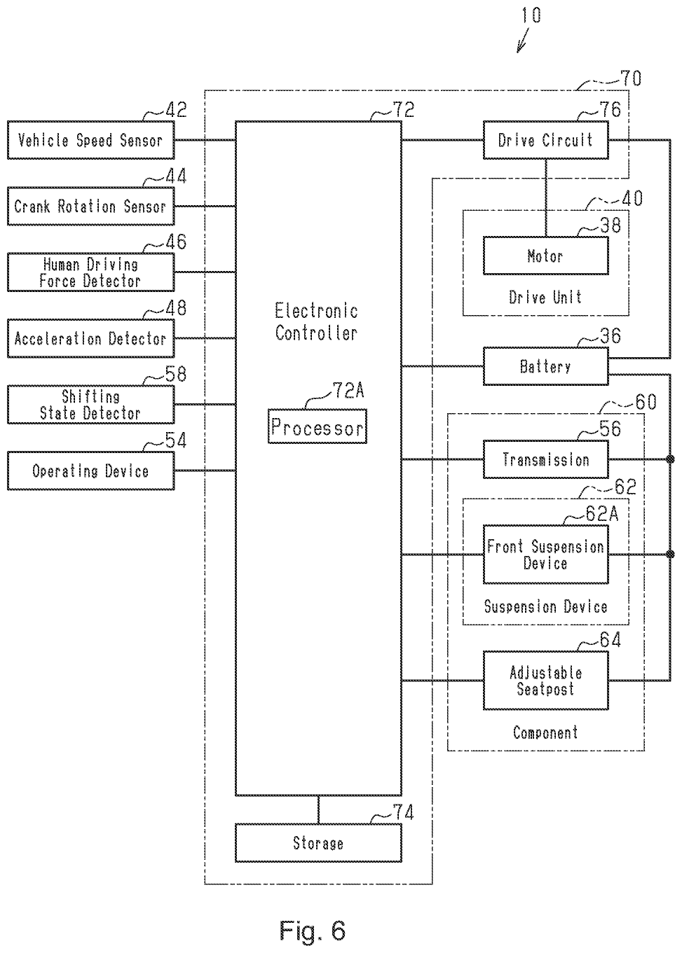

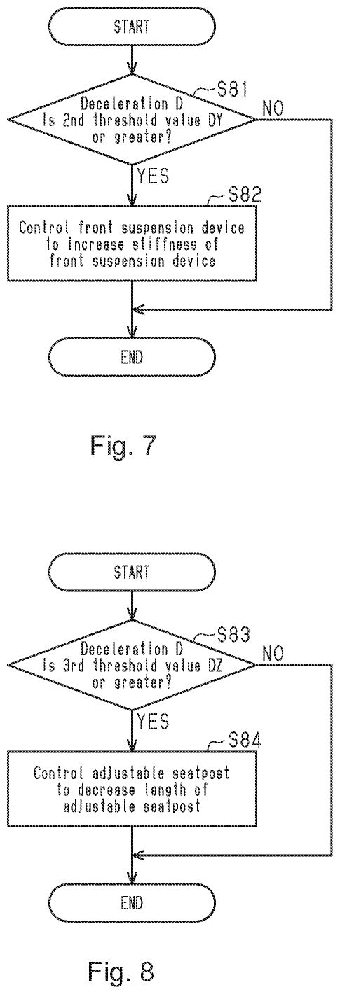

The control device 70 in accordance with a third embodiment will now be described with reference to FIGS. 6 to 9. The control device 70 of the third embodiment is configured in the same manner as the control device 70 of the first or second embodiment except in that at least one of the processes of the flowcharts shown in FIGS. 7 to 9 is performed in addition to the process of the flowchart shown in FIG. 3 or 5. Thus, same reference numerals are given to those components of the control device 70 in the third embodiment that are the same as the corresponding components in the first and second embodiments. Such components will not be described in detail.

In the present embodiment, the electronic controller 72 is configured to control a human-powered vehicle component 60 in accordance with information related to the vehicle speed V of the human-powered vehicle 10. The component 60 is provided in the transmission path of the human driving force H in the human-powered vehicle 10 and includes at least one of at least one transmission 56 configured to change the transmission ratio R, at least one suspension device 62, and an adjustable seatpost 64.

The suspension device 62 includes an electric actuator for actuating the suspension device 62. The suspension device 62 further includes a drive circuit that controls the electric power applied to the electric actuator. The electric actuator includes an electric motor. The electric motor of the electric actuator can be replaced with a solenoid. The drive circuit drives the electric actuator in accordance with a control signal from the electronic controller 72.

The suspension device 62 includes at least one of a rear suspension device and a front suspension device 62A. The suspension device 62 absorbs impacts applied to the wheel 14. The suspension device 62 can be a hydraulic suspension or an air suspension. The suspension device 62 includes a first portion and a second portion. The second portion is fitted to the first portion and is movable relative to the first portion. An actuation state of the suspension device 62 includes, for example, a locked state in which relative movement of the first portion and the second portion is restricted and an unlocked state in which relative movement of the first portion and the second portion is permitted. The electric actuator switches the actuation states of the suspension device 62. The locked state of the suspension device 62 includes a state in which the first portion and the second portion slightly move relative to each other in a case where a strong force is applied to the wheel 14. Instead of or in addition to the locked state and the unlocked state, the actuation state of the suspension device 62 can include at least one of a plurality of actuation states that differ in damping force and a plurality of actuation states that differ in stroke amount.

The rear suspension device is configured to be provided on the frame 18 of the human-powered vehicle 10. The rear suspension is provided between a frame body of the frame 18 and a swingarm that supports the rear wheel 14A. The rear suspension device absorbs impacts applied to the rear wheel 14A. The front suspension device 62A is configured to be provided between the frame 18 and the front wheel 14B of the human-powered vehicle 10. The front suspension is provided on the front fork 30. The front suspension device 62A absorbs impacts applied to the front wheel 14B.

The adjustable seatpost 64 includes an electric actuator. The adjustable seatpost 64 further includes a drive circuit that controls the electric power applied to the electric actuator. The electric actuator includes an electric motor. The electric motor of the electric actuator can be replaced with a solenoid. The drive circuit drives the electric actuator in accordance with a control signal from the electronic controller 72. The adjustable seatpost 64 is provided on a seat tube and is configured to change the height of a saddle. The adjustable seatpost 64 includes an electric seatpost or a mechanical seatpost. An electric seatpost is extended and retracted by the force of an electric actuator. A mechanical seatpost is extended by at least spring force or pneumatic force with a valve controlled by the force of an electric actuator, and the mechanical seatpost is retracted by adding human force. The mechanical seatpost includes a hydraulic seatpost and a hydraulic/pneumatic seatpost.

In a case where the component 60 includes at least one suspension device 62, the at least one suspension device 62 includes, for example, the front suspension device 62A. Further, the electronic controller 72 controls the front suspension device 62A to increase the stiffness of the front suspension device 62A in a case where the deceleration D of the human-powered vehicle 10 in the traveling direction of the human-powered vehicle 10 is greater than or equal to a second threshold value DY. The second threshold value DY is, for example, equal to the first threshold value DX. The second threshold value DY can be greater than the first threshold value DX.

A process for shifting a control state in which the electronic controller 72 controls the front suspension device will now be described with reference to FIG. 7. For example, in a case where electric power is supplied to the electronic controller 72, the electronic controller 72 starts the process of the flowchart shown in FIG. 7 from step S81. In a case where the process of the flowchart shown in FIG. 7 ends, the electronic controller 72 repeats the process from step S81 in predetermined cycles, for example, until the supply of electric power stops.

In step S81, the electronic controller 72 determines whether the deceleration D is greater than or equal to the second threshold value DY. In a case where the deceleration D is not greater than or equal to the second threshold value DY, the electronic controller 72 ends processing. In a case where the deceleration D is greater than or equal to the second threshold value DY, the electronic controller 72 proceeds to step S82. In step S82, the electronic controller 72 controls the front suspension device 62A to increase the stiffness of the front suspension device 62A and then ends processing. In a case where the front suspension device 62A is in the unlocked state, the front suspension device 62A is changed to the locked state in step S82.

In a case where the deceleration D of the human-powered vehicle 10 in the traveling direction of the human-powered vehicle 10 is greater than or equal to the second threshold value DY and less than or equal to a sixth threshold value DR, the electronic controller 72 can be configured to control the front suspension device 62A to increase the stiffness of the front suspension device 62A. The second threshold value DY is equal to the first threshold value DX, and the sixth threshold value DR is equal to the fifth threshold value DV.

In a case where the component 60 includes the adjustable seatpost 64, for example, the electronic controller 72 controls the adjustable seatpost 64 to decrease the length of the adjustable seatpost 64 in a case where the deceleration D of the human-powered vehicle 10 in the traveling direction of the human-powered vehicle 10 is greater than or equal to a third threshold value DZ. The third threshold value DZ is, for example, equal to the first threshold value DX. The third threshold value DZ can be greater than the first threshold value DX.

A process executed by the electronic controller 72 to control the adjustable seatpost 64 will now be described with reference to FIG. 8. For example, in a case where electric power is supplied to the electronic controller 72, the electronic controller 72 starts the process of the flowchart shown in FIG. 8 from step S83. In a case where the process of the flowchart shown in FIG. 8 ends, the electronic controller 72 repeats the process from step S83 in predetermined cycles, for example, until the supply of electric power stops.

In step S83, the electronic controller 72 determines whether the deceleration D is greater than or equal to the third threshold value DZ. In a case where the deceleration D is not greater than or equal to the third threshold value DZ, the electronic controller 72 ends processing. In a case where the deceleration D is greater than or equal to the third threshold value DZ, the electronic controller 72 proceeds to step S84. In step S84, the electronic controller 72 controls the adjustable seatpost 64 to decrease the length of the adjustable seatpost 64 and then ends processing.

In a case where the deceleration D of the human-powered vehicle 10 in the traveling direction of the human-powered vehicle 10 is greater than or equal to the third threshold value DZ and less than a seventh threshold value DS, the electronic controller 72 can be configured to control the adjustable seatpost 64 to decrease the length of the adjustable seatpost 64. The third threshold value DZ is equal to the first threshold value DX, the seventh threshold value DS is equal to the fifth threshold value DV.

In a case where the component 60 includes at least one transmission 56, for example, the electronic controller 72 controls the transmission 56 to decrease the transmission ratio R in a case where the deceleration D of the human-powered vehicle 10 in the traveling direction of the human-powered vehicle 10 is greater than or equal to a fourth threshold value DW. The fourth threshold value DW is, for example, equal to the first threshold value DX.

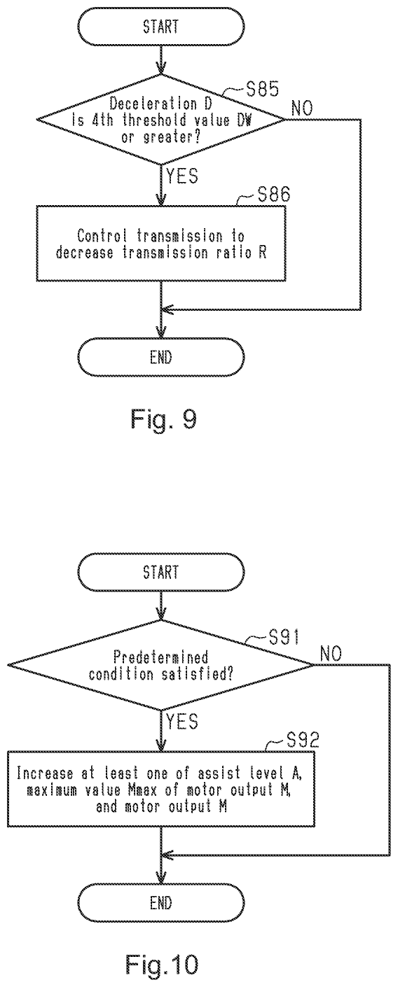

A process executed by the electronic controller 72 to control the transmission 56 will now be described with reference to FIG. 9. For example, in a case where electric power is supplied to the electronic controller 72, the electronic controller 72 starts the process of the flowchart shown in FIG. 9 from step S85. In a case where the process of the flowchart shown in FIG. 9 ends, the electronic controller 72 repeats the process from step S85 in predetermined cycles, for example, until the supply of electric power stops.

In step S85, the electronic controller 72 determines whether the deceleration D is greater than or equal to the fourth threshold value DW. In a case where the deceleration D is not greater than or equal to the fourth threshold value DW, the electronic controller 72 ends processing. In a case where the deceleration D is greater than or equal to the fourth threshold value DW, the electronic controller 72 proceeds to step S86. In step S86, the electronic controller 72 controls the transmission 56 to decrease the transmission ratio R and then ends processing.

In a case where the deceleration D of the human-powered vehicle 10 in the traveling direction of the human-powered vehicle 10 is greater than or equal to the fourth threshold value DW and less than or equal to an eighth threshold value DT, the electronic controller 72 can be configured to control the transmission 56 to decrease the transmission ratio R. The fourth threshold value DW is equal to the first threshold value DX, the eighth threshold value DT is equal to the fifth threshold value DV.

### Modifications

The description related with the above embodiments exemplifies, without any intention to limit, applicable forms of a human-powered vehicle control device according to the present disclosure. In addition to the embodiments described above, the human-powered vehicle control device according to the present disclosure is applicable to, for example, modifications of the above embodiments that are described below and combinations of at least two of the modifications that do not contradict each other. In the modifications described hereafter, same reference numerals are given to those components that are the same as the corresponding components of the above embodiments. Such components will not be described in detail.

In the first embodiment and a modification of the first embodiment, any configuration can be omitted as long as the electronic controller 72 increases at least one of the assist level A of the motor 38, the maximum value Mmax of the output M of the motor 38, and the output M of the motor 38 in a case where the predetermined condition is satisfied. The predetermined condition can include only the first condition. A process for shifting the control state in which the electronic controller 72 controls the motor 38 will now be described with reference to FIG. 10. For example, in a case where the electric power is supplied to the electronic controller 72, the electronic controller 72 starts the process of the flowchart shown in FIG. 10 from step S91. In a case where the process of the flowchart shown in FIG. 10 ends, the electronic controller 72 repeats the process from step S91 in predetermined cycles, for example, until the supply of electric power stops.

In step S91, the electronic controller 72 determines whether the predetermined condition is satisfied. In a case where the predetermined condition is not satisfied, the electronic controller 72 ends processing. In a case where the predetermined condition is satisfied, the electronic controller 72 proceeds to step S92.

In step S92, the electronic controller 72 increases at least one of the assist level A of the motor 38, the maximum value Mmax of the output M of the motor 38, and the output M of the motor 38 and then ends processing.

Instead of or in addition to step S25 shown in FIG. 5, the electronic controller 72 can provide an affirmative determination in a case where a predetermined first period elapses from when the first or third process is started. Instead of or in addition to step S25 shown in FIG. 5, the electronic controller 72 can provide an affirmative determination in a case where a predetermined second period elapses from when the second or third process is started. The processes of the flowcharts shown in FIGS. 7, 8, and 9 in the third embodiment can be performed independently from the first or second embodiment.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three.

What is claimed is:

1. A control device for a human-powered vehicle, the control device comprising:
an electronic controller configured to control a motor that applies a propulsion force to the human-powered vehicle,
in a case where a predetermined condition is satisfied, the electronic controller being configured to increase at least one of an assist level of the motor, a maximum value of an output of the motor, and the output of the motor, and
the predetermined condition including a first condition in which deceleration of the human-powered vehicle in a traveling direction of the human-powered vehicle is greater than or equal to a first threshold value.

2. The control device according to claim 1, wherein
the predetermined condition further includes a second condition in which an input shaft to which a human driving force is input is rotating.

3. The control device according to claim 1, wherein
the predetermined condition further includes a third condition in which a human driving force is input to the human-powered vehicle.

4. The control device according to claim 1, wherein
the predetermined condition further includes a fourth condition in which an operating device of a brake device of the human-powered vehicle is not being operated.

5. The control device according to claim 1, wherein
the predetermined condition includes a fifth condition in which a vehicle speed of the human-powered vehicle increases immediately before the first condition is satisfied.

6. The control device according to claim 1, wherein
the human-powered vehicle includes a transmission,
the transmission is provided in a transmission path of a human driving force of the human-powered vehicle and configured to change a transmission ratio, and
the electronic controller is configured to control the motor in accordance with first information related to a present transmission ratio of the transmission and second information related to the transmission ratio corresponding to at least one of a first traveling state of the human-powered vehicle and a first traveling environment of the human-powered vehicle.

7. The control device according to claim 6, wherein
the predetermined condition includes a sixth condition in which the first information differs from the second information.

8. The control device according to claim 1, wherein
the electronic controller is configured to control a component of the human-powered vehicle in accordance with information related to a vehicle speed of the human-powered vehicle,
the component includes at least one of:
a transmission provided in a transmission path of a human driving force in the human-powered vehicle and configured to change a transmission ratio,
at least one suspension device, and
an adjustable seatpost.

9. The control device according to claim 8, wherein
the component includes the at least one suspension device,
the at least one suspension device includes a front suspension device, and
the electronic controller is configured to control the front suspension device to increase stiffness of the front suspension device in a case where the deceleration of the human-powered vehicle in the traveling direction of the human-powered vehicle is greater than or equal to a second threshold value.

10. The control device according to claim 8, wherein
the component includes the adjustable seatpost, and
the electronic controller is configured to control the adjustable seatpost to decrease a length of the adjustable seatpost in a case where the deceleration of the human-powered vehicle in the traveling direction of the human-powered vehicle is greater than or equal to a third threshold value.

11. The control device according to claim 8, wherein
the component includes the transmission, and
the electronic controller controls the transmission to decrease the transmission ratio in a case where the deceleration of the human-powered vehicle in the traveling direction of the human-powered vehicle is greater than or equal to a fourth threshold value.
